(19) United States
(12) Patent Application Publication
(10) Pub. No.: US 2026/0266599 A1
(43) Pub. Date: Sep. 10, 2026

(54) LINE LASER MEASURING DEVICE

(71) Applicant: Mitutoyo Corporation, Kawasaki (JP)

(72) Inventors: Toshiyuki Mawatari, Tokyo (JP); Tsukasa Ichimi, Aichi (JP)

(21) Appl. No.: 19/546,975

(22) Filed: Feb. 23, 2026

(30) Foreign Application Priority Data
Mar. 4, 2025 (JP) 2025-033420
Oct. 21, 2025 (JP) 2025-177421

(51) Int. Cl. G01B 11/25; G01B 11/02

(52) U.S. Cl. CPC G01B 11/2518; G01B 11/026

(57) ABSTRACT

A line laser measuring device that can be easily positioned at the appropriate height is provided. The line laser measuring device comprises: a probe light source that irradiates a target object with a probe light, which is a line laser light; a guide light source that irradiates the target object with a guide light at an angle different from that of the probe light; an imaging optical system that converges a reflected light, which is the probe light reflected by the target object, and forms an image; a two-dimensional imager that receives the reflected light converged by the imaging optical system; and a profile calculation unit that calculates, based on the imaging position of the reflected light on the receiving surface of the two-dimensional imager, a profile along the line where the probe light is irradiated on the target object based on a triangulation technique, wherein the irradiation range of the probe light and the irradiation range of the guide light overlap at a reference height within the profile detection range of the two-dimensional imager.

### CROSS-REFERENCE TO RELATED APPLICATIONS

This non-provisional application claims priority under 35 U.S.C. § 119(a) from Japanese Patent Application No. 2025-033420, filed on Mar. 4, 2025, and Patent Application No. 2025-177421, filed on Oct. 21, 2025, the entire contents of which are incorporated herein by reference.

### FIELD

The present disclosure relates to a line laser measuring device that non-contact measures the profile of a measurement target using a triangulation technique.

### BACKGROUND

Conventionally, a measuring device is known that irradiates a laser beam onto the surface of a measurement target, receives the reflected or scattered light with an image sensor, and calculates the position of the measurement target's surface using a triangulation technique (see, for example, Japanese Patent Application Publication No. 2002-139311).

Such measuring devices may be configured as handheld devices for users to hold while performing measurements, in addition to being fixed to measuring fixtures for use. Additionally, configurations exist where a measuring device is mounted on the distal end portion of industrial robots for use.

FIG. 8 is a schematic diagram illustrating a conventional non-contact measuring device using a triangulation technique. As shown in FIG. 8, this measuring device comprises a measuring head 10 and an external controller 20. Within the measuring head 10, a probe light source 15 that emits laser light LS1 as a probe light for measurement toward a workpiece W that is a measurement target, and a two-dimensional imager (image sensor) 17 positioned on an optical axis non-parallel to the optical axis of the laser light LS1, are provided. Furthermore, in the measuring head 10, an illumination lens 151 for focusing the laser light LS1 emitted from the probe light source 15, and an imaging optical system 16 for forming an image of the laser light reflected or scattered by the workpiece W onto the two-dimensional imager 17 are provided. The respective positions and angles of the illumination lens 151, the imaging optical system 16, and the two-dimensional imager 17 are determined in accordance with the Scheimpflug principle. Furthermore, the measuring head 10 is provided with an internal controller 19 equipped with a data processing circuit 191, a calculation unit 192, and a drive circuit 193, etc. These are mounted on an electronic board.

To measure the workpiece W using this measuring device, the measuring head 10 is directed toward the workpiece W, and laser light LS1 is irradiated onto the workpiece W from the probe light source 15. The reflected light and scattered light of this laser light LS1 from the workpiece W are then captured by the two-dimensional imager 17. In the measuring device, since a parallax D is provided between the probe light source 15 and the two-dimensional imager 17, the displacement L of the workpiece W in the height direction can be determined using a triangulation technique based on the position information Δx captured by the two-dimensional imager 17, the focal length f, and the parallax D. By using the laser light LS1 as a line laser light, the height profile along the irradiation range of the laser light LS1 on the workpiece W (the bright line where the laser light LS1 is reflected by the workpiece W) can be measured in one shot.

### SUMMARY

### Problem to be Solved

Conventional measuring devices are typically fixed to fixtures or the like and used after being pre-adjusted to an appropriate height so that the distance between the workpiece W and the measuring head 10 is roughly at the center of the height measurement range. On the other hand, when such a measuring device is configured as a so-called handheld device for the user to hold while performing measurements, the user must hold the device at an appropriate height to position the workpiece W within the device's height measurement range. Users unfamiliar with handling the device may struggle to position it at the appropriate height.

Furthermore, when the measuring device is used mounted on a robot, the operator must refer to the screen of the computer connected to the robot during the teaching process. However, in factory environments, it is often impossible to place a computer near the robot, and the operator is forced to work while checking a computer located at a distance. Moreover, performing the operation of the input device used for teaching operations (the so-called teaching pendant) and the operation of the computer simultaneously is not easy, leading to reduced work efficiency.

An embodiment of the present invention was made in consideration of the above issues and aims to provide a line laser measuring device with improved operability.

### Means for Solving the Problem

To solve the above problem, the line laser measuring device according to an embodiment of the present invention comprises: a probe light source that irradiates a target object with a probe light, which is a line laser light; a guide light source that irradiates the target object with a guide light at an angle different from that of the probe light; an imaging optical system that converges a reflected light, which is the probe light reflected by the target object, and forms an image; a two-dimensional imager that receives the reflected light converged by the imaging optical system; and a profile calculation unit that calculates, based on the imaging position of the reflected light on the receiving surface of the two-dimensional imager, a profile along the line where the probe light is irradiated on the target object based on a triangulation technique, wherein the irradiation range of the probe light and the irradiation range of the guide light overlap at a reference height within the profile detection range of the two-dimensional imager.

### BRIEF DESCRIPTION OF THE DRAWINGS

FIG. 1 is a schematic diagram showing a configuration of the line laser measuring device 1 of an embodiment of the present invention.

FIG. 2 is a diagram showing a configuration of the measurement head.

FIG. 3 shows an example of the arrangement of the measurement button 13.

FIG. 4 shows a timing chart illustrating the drive conditions for the configurable probe light source 15 and guide light source 18.

FIG. 5 is a diagram showing the relationship between the height of the line laser measuring device 1 relative to the workpiece W and the irradiation position of the guide light.

FIG. 6 is a schematic diagram showing an example of the measuring head 10 attached to the distal end portion of the robotic arm RA, together with a user holding the teaching pendant TP.

FIG. 7 is a diagram showing the relationship between the irradiation range of the probe light and the irradiation range of the guide light in a modified embodiment.

FIG. 8 is a schematic diagram illustrating a conventional non-contact measuring device using a triangulation technique.

### EMBODIMENTS

Hereinafter, embodiments of the present invention will be described with reference to the drawings. In the following description and drawings, the same reference numeral is attached to the same functional parts, and the functional parts once explained are either omitted or explained to the extent necessary.

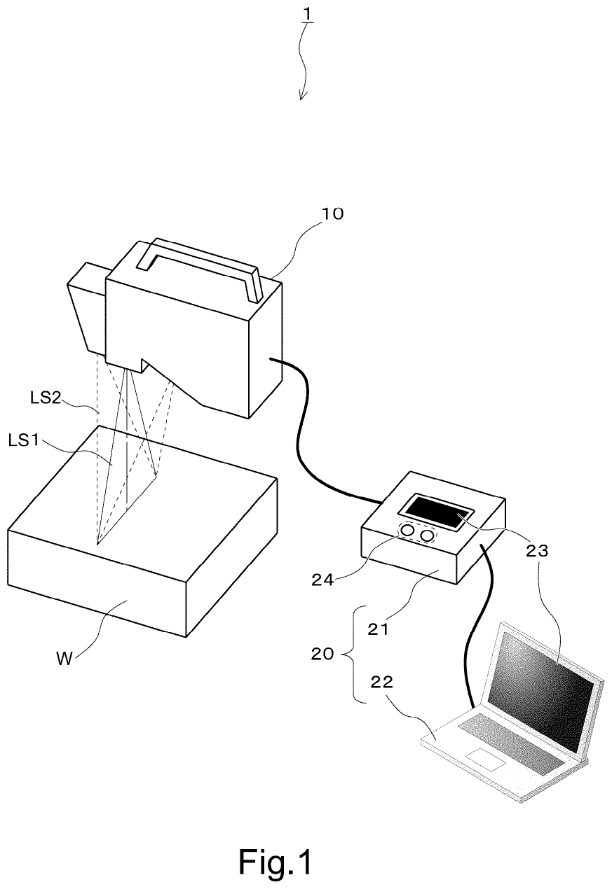

FIG. 1 is a schematic diagram showing a configuration of a line laser measuring device 1 according to an embodiment of the present invention. The line laser measuring device 1 comprises a measuring head 10 and an external controller 20.

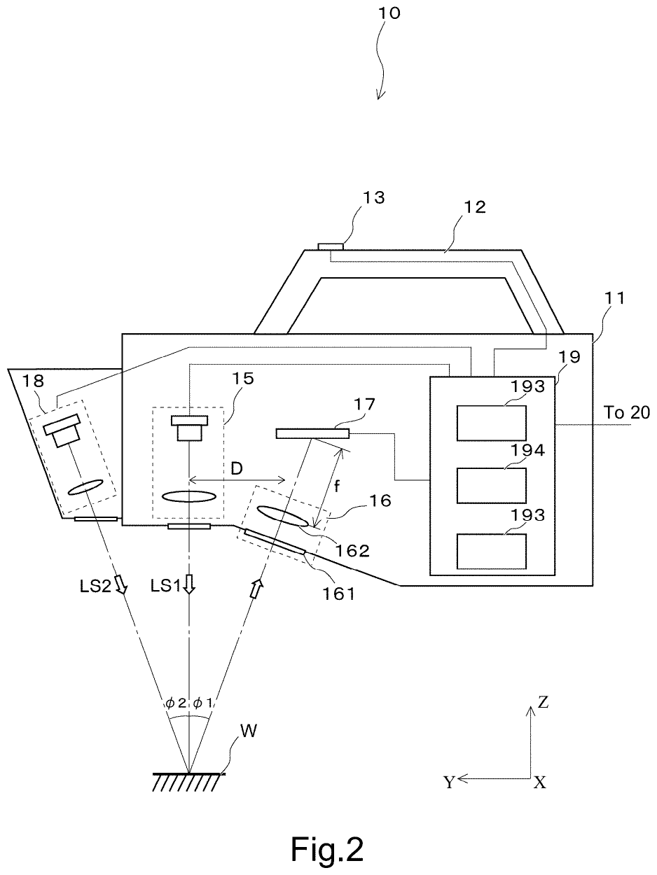

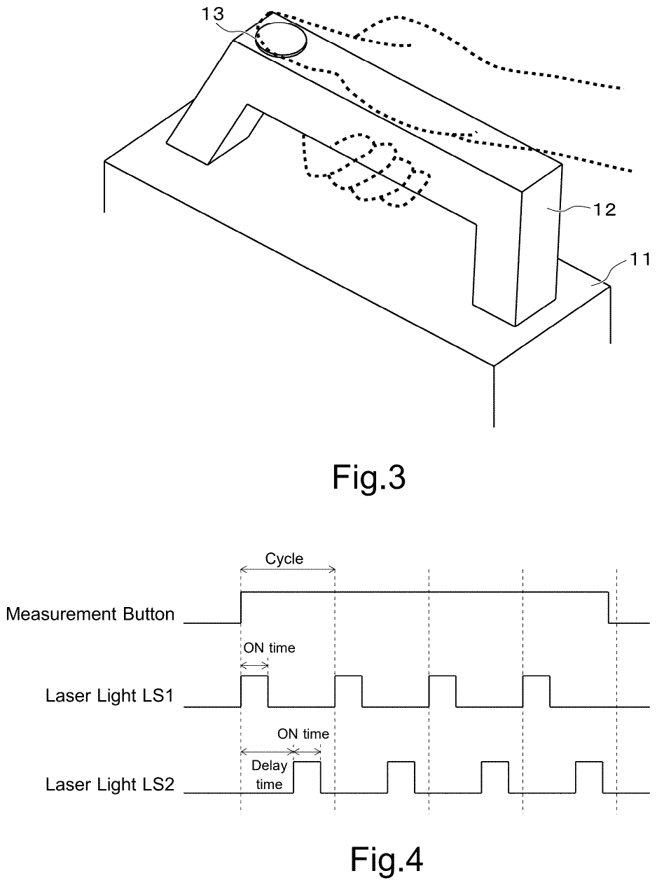

FIG. 2 is a schematic diagram showing a configuration of the measuring head 10. The measuring head 10 includes a probe light source 15, an imaging optical system 16, and a two-dimensional imager 17 within a housing 11. On the front of housing 11, a guide light source 18 is fixedly provided. On top of housing 11, a handle 12 that is to be gripped by the user during measurement is fixedly provided. Furthermore, a measurement button 13 is arranged in a position operable by the user's fingers when grasping the handle 12. The measurement button 13 should be provided on the upper surface of the handle 12, for example, as shown in FIG. 3, so that it can be pressed with the thumb when gripping. The handle 12 and/or the guide light source 18 may be detachable from the housing 11.

The probe light source 15, the imaging optical system 16, and the two-dimensional imager 17 are provided within the housing 11. The probe light source 15 irradiates laser light LS1 toward the workpiece W as a probe light used for measurement. The laser light LS1 emitted by the probe light source 15 is a line laser light with a beam shape formed into a straight line. The configuration of the probe light source 15 is arbitrary, but it may be configured, for example, by a laser light source and a cylindrical lens.

Hereafter, the Z-axis is defined as the irradiation direction of laser light LS1 from probe light source 15, the X-axis as the direction perpendicular to the Z-axis where the irradiation range of laser light LS1 extends linearly, and the Y-axis as the direction perpendicular to both the X-axis and Z-axis.

The imaging optical system 16 converges a reflected light, which is the laser light LS1 reflected by the workpiece W, and forms an image. The imaging optical system includes an optical filter 161, an image-forming lens and other components. The two-dimensional imager 17 is provided on an optical axis that is non-parallel to the optical axis of the laser light LS1 and receives the reflected light converged by the imaging optical system 16. As for the two-dimensional imager 17, devices such as CCD (Charge Coupled Device) or CMOS (Complementary Metal-Oxide Semiconductor) are used. The two-dimensional imager 17 outputs a signal corresponding to the intensity of the received light. The respective positions and angles of the probe light source 15, the imaging optical system 16, and the two-dimensional imager 17 are determined in accordance with the Scheimpflug principle. The two-dimensional imager 17 outputs a signal reflecting the imaging position of the laser light LS1. The signal output by the two-dimensional imager 17 is, for example, a voltage signal representing the intensity of light detected by each pixel constituting the two-dimensional imager 17.

When measuring the profile of workpiece W using the line laser measuring device 1, the measuring head 10 is directed toward the workpiece W, and laser light LS1 is irradiated from the probe light source 15 toward the workpiece W. This laser light LS1 is then reflected by the workpiece W, and the reflected light forms an image on the light-receiving surface of the two-dimensional imager 17 via the imaging optical system 16. In the line laser measuring device 1, a parallax is provided between the probe light source 15 and the two-dimensional imager 17. Consequently, the position of the image formed changes depending on the height (profile) of the contour of the workpiece W onto which the laser light LS1 is irradiated. In the line laser measuring device 1, the height profile of the workpiece W can be determined using triangulation, based on the position at which the laser light LS1 forms an image on the two-dimensional imager 17, the focal length f of the imaging optical system 16, and the parallax D.

A guide light source 18 is provided at the front of the housing 11 to irradiate laser light LS2 toward the workpiece W as a guide light. The laser light LS2 is irradiated toward the workpiece W at an angle different from that of the laser light LS1 within the YZ plane. That is, the optical axes of the laser light LS2 and the laser light LS1 are non-parallel. In the present embodiment, the laser light LS2 emitted from the guide light source 18 is a line laser light with a beam shape formed into a straight line. The configuration of the guide light source 18 is arbitrary, but it may be configured, for example, by a laser light source and a cylindrical lens. In the example shown in FIG. 2, the guide light source 18 is provided externally attached to the housing 11. However, the guide light source 18 may be configured to be contained within the housing 11.

The irradiation direction of laser light LS2 from guide light source 18 is adjusted so that the irradiation range of laser light LS1 and the irradiation range of laser light LS2 overlap at the reference height within the profile detection range of two-dimensional imager 17. In this embodiment, since both the laser light LS1 (probe light) and the laser light LS2 (guide light) are line laser lights, the laser light LS1 and the laser light LS2 overlap in a line at the reference height. The reference height may be set, for example, at the center within the profile detection range of the two-dimensional imager 17. Furthermore, as shown in FIG. 2, the guide light source 18 may be positioned such that the angle φ2 formed by the laser light LS1 and the laser light LS2 is approximately equal to the angle φ1 formed by the laser light LS1 and the main optical axis of the imaging optical system 16 (φ1=φ2). By irradiating the laser light LS2 as a guide light in this manner, the user can easily adjust the height of the line laser measuring device 1, as described later.

The laser light LS1 and laser light LS2 should preferably have different wavelengths. This allows the probe light and guide light to be visually distinguished. It is preferable that the wavelength of the laser light LS1, which is the probe light, is shorter than the wavelength of the laser light LS2, which is the guide light. As a specific example, the laser light LS1 may be blue, and the laser light LS2 may be red. Using a shorter wavelength for the probe light improves measurement accuracy. The imaging optical system 16 may be provided with an optical filter 161 that transmits the probe light and attenuates the guide light. In this way, it is possible to suppress the guide light from entering the two-dimensional imager 17 and affecting measurements as noise.

In the housing 11, an internal controller 19 is further provided. The internal controller 19 controls the various components in the measuring head 10. For example, the internal controller 19 includes a drive circuit 193 that performs drive control of the probe light source 15 and the guide light source 18, and an imaging control unit 194 that controls the detection operation of the two-dimensional imager 17. Furthermore, the internal controller 19 has the function of the profile calculation unit 195. It processes the signal output by the two-dimensional imager 17 and calculates the profile along the line on the workpiece W to which the laser light LS1 (probe light) was irradiated, based on the position where the reflected light forms an image on the light-receiving surface of the two-dimensional imager 17, using a triangulation technique. Additionally, the internal controller 19 handles communication with the external controller 20.

While the measurement button 13 is pressed, the internal controller 19 causes the two-dimensional imager 17 and the profile calculation unit 195 to operate and calculate the profile. At that time, the internal controller 19 drives the probe light source 15 and the guide light source 18 according to conditions set via the external controller 20. For example, while the measurement button 13 is pressed, the internal controller 19 controls the probe light source 15 and guide light source 18 such that the laser light LS1 (probe light) and laser light LS2 (guide light) are not irradiated simultaneously, but rather irradiated alternately. Furthermore, the internal controller 19 causes the two-dimensional imager 17 and the profile calculation unit 195 to activate while laser light LS1 is being emitted, while it deactivates the two-dimensional imager 17 and/or the profile calculation unit 195 while laser light LS2 is being emitted. With such control, it is possible to suppress the effect of laser light LS2 on the measurement as noise.

The external controller 20 is provided separately from the measuring head 10 and is connected thereto via a cable. In the example shown in FIG. 1, the external controller 20 is realized by combining a dedicated control box 21 and a general-purpose computer system 22. Still, it may be realized by the control box 21 alone or by the computer system 22 alone. In the external controller 20, displays 23, input buttons 24, etc., are provided as input/output interfaces for setting conditions such as the drive conditions for the probe light source 15 and guide light source 18, and measurement conditions. The displays 23 may be provided on both the control box 21 and the computer system 22, as shown in FIG. 1. The display 23 provided on the control box 21 and the display 23 provided on the computer system 22 may display different contents.

The external controller 20 provides an interface for setting the drive conditions for the probe light source 15 and the guide light source 18, such as the cycle, the ON time of the probe light, the ON time of the guide light, and the delay time from the start of probe light irradiation to the start of guide light irradiation, as shown in FIG. 4. Such an interface may be provided, for example, by the display 23 and input buttons 24 equipped on the control box 21. Alternatively, the display 23 of the control box 21 may be configured with a touch panel.

The display 23 shows profiles calculated by the internal controller 19 as measurement results, in addition to serving as an interface for settings. For example, the display 23 may display the profile calculated while the measurement button 13 is being manipulated (pressed), constantly updating it to the latest one. Additionally, when the manipulation (pressing) of the measurement button 13 is released, the display 23 may continue to show the profile calculated immediately before the release of the measurement button 13 (i.e., the last calculated profile). Such a profile may be displayed on the display 23 that is provided in the computer system 22. For this profile, it is also possible to perform shape measurements such as gap dimension measurement or step height measurement.

In addition to the above configuration, the line laser measuring device 1 may be provided with a storage unit in the measuring head 10 and/or the external controller 20, enabling it to store any number of profiles calculated by the internal controller 19. Moreover, the line laser measuring device 1 may be configured to read out a profile stored in the storage unit and display it on the display 23. For the read profile, it is also possible to perform shape measurements such as gap dimension measurement or step height measurement.

Next, the procedure for performing measurements using the line laser measuring device 1 configured as described above will be explained.

The measurement using the line laser measuring device 1 starts in a state where the user grasps the handle 12 of the line laser measuring device 1 and holds the line laser measuring device 1 directed toward the workpiece W. While the user presses the measurement button 13, the probe light source 15 emits the laser light LS1, and the guide light source 18 emits the laser light LS2. As described above, the laser light LS1 and the laser light LS2 are emitted alternately. The user adjusts the height (distance from the workpiece W) of the line laser measuring device 1 while visually confirming the linear irradiation area (spot) where the laser light LS1 and the laser light LS2 are reflected from the surface of the workpiece W.

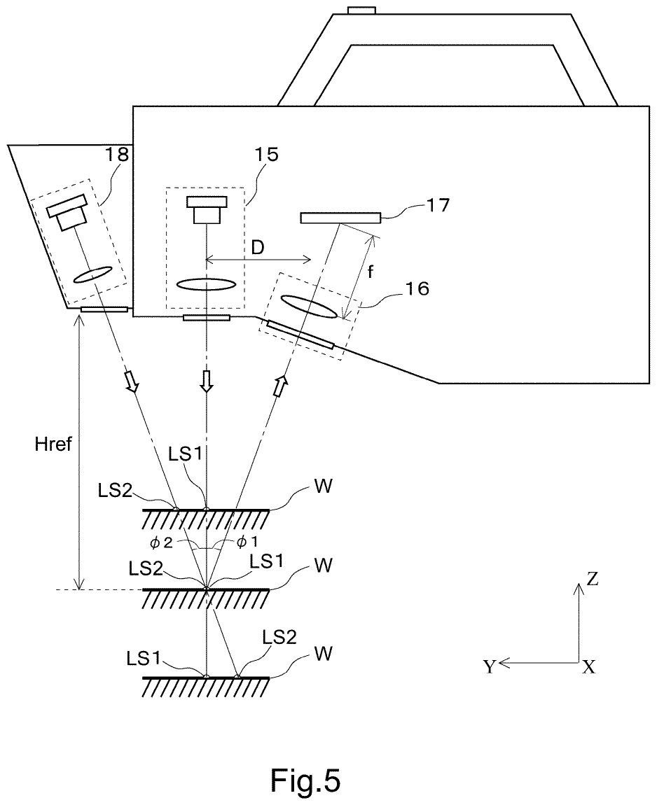

As shown in FIG. 5, when the surface of the workpiece W matches the reference height Href within the profile detection range, the irradiation range of the laser light LS1 overlaps with the irradiation range of the laser light LS2. Conversely, when the surface of the workpiece W is closer than the reference height Href, the irradiation range of laser light LS2 shifts to the left side (in the +Y axis direction) of the irradiation range of laser light LS1 in FIG. 5. Furthermore, when the surface of the workpiece W is farther than the reference height Href within the profile detection range, the irradiation range of laser light LS2 shifts to the right side (−Y axis direction) of the irradiation range of laser light LS1 in FIG. 5. The user can easily bring the profile of workpiece W within the height measurement range by manually adjusting the height of the line laser measuring device to overlap the irradiation ranges of laser light LS1 and laser light LS2. At this time, the arrangement ensures that the angle φ2 formed by laser light LS1 and laser light LS2 is approximately equal to the angle φ1 formed by laser light LS1 and the main optical axis of the imaging optical system 16. Thereby, adjusting for distance becomes easy both visually and intuitively.

Since the laser light LS1 and the laser light LS2 have different wavelengths (colors), the user can distinguish and recognize laser light LS1 and laser light LS2. The user can align the probe light, which is the laser light LS1, with the area where the profile is to be acquired, while adjusting the height at which the line laser measuring device 1 is held up and down so that the irradiation range of the guide light, which is the laser light LS2, overlaps with the irradiation range of the laser light LS1. As a result, the surface of the workpiece W can be easily positioned to match the reference height of the profile detection range.

While the user presses the measurement button 13, in parallel with the irradiation of the laser light LS1 and the laser light LS2, the two-dimensional imager 17 detects the reflected light of the laser light LS1 on the surface of the workpiece W, and the profile calculation unit 195 continuously calculates the profile at the cycle shown in the timing chart of FIG. 4. The profile calculated by the profile calculation unit 195 is continuously displayed on the display 23.

Then, in a state the user holds the line laser measuring device 1 at the height where the irradiation range of the laser beam LS2 overlaps with the irradiation range of the laser light LS1, by releasing the measurement button 13, the irradiation of the laser light LS1 and the laser light LS2, the two-dimensional imager 17, and the profile calculation unit 195 are deactivated and the display 23 shows the profile calculated immediately before the measurement button 13 was released.

In this manner, the profile can be measured and displayed on the display 23 while the surface of the workpiece W is easily positioned to match the reference height within the profile detection range.

### Modification of Embodiment

It should be noted that the embodiments of the present invention are not limited to the above-described embodiments, and any variation, improvement, and the like are included in the embodiments of the present invention to the extent that the object can be achieved. In other words, changes can be made as appropriate within the scope of the technical concept expressed in the present invention, and forms with such changes and improvements are included in the technical scope of the present invention.

The line laser measuring device 1 is not limited to a handheld type operated by the user gripping the handle 12; it can also be used mounted on the distal end portion of the robotic arm of an industrial robot.

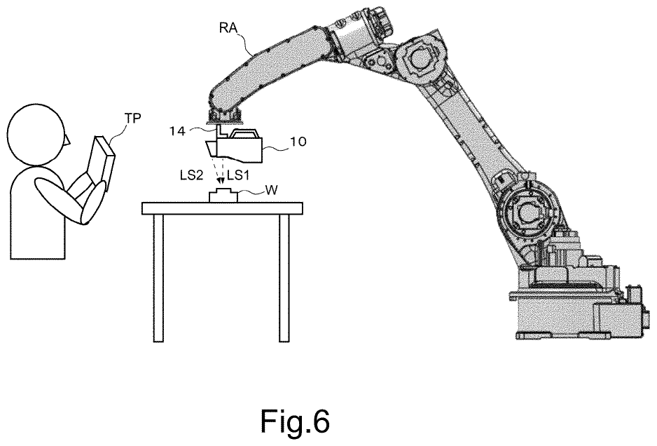

FIG. 6 is a schematic diagram showing an example of the measuring head 10 attached to the distal end portion of the robotic arm RA. In this case, the measuring head 10 is fixed to the flange portion of the robotic arm RA via a bracket 14 and moves along a predetermined trajectory relative to the measurement target W in accordance with the movement of the robotic arm RA.

From the measuring head 10 mounted on the industrial robot, the line laser light LS1 is emitted by the probe light source 15, and the line laser light LS2 is emitted by the guide light source 18. The operator can directly observe the irradiation range of the laser lights LS1 and LS2 formed on the measurement target W while operating the robot arm RA using the teaching pendant TP. This eliminates the need to repeatedly check a computer screen located at a distance, as was conventionally required. Instead, the operator can intuitively proceed with the teaching operation while observing the relative positions of the guide laser lights.

Furthermore, in this embodiment, instead of manipulation via the measurement button 13, the measurement operation may be started and stopped based on control signals from the teaching pendant TP. Thereby, the registration of the robot's movements and the measurement operation can be efficiently performed concurrently.

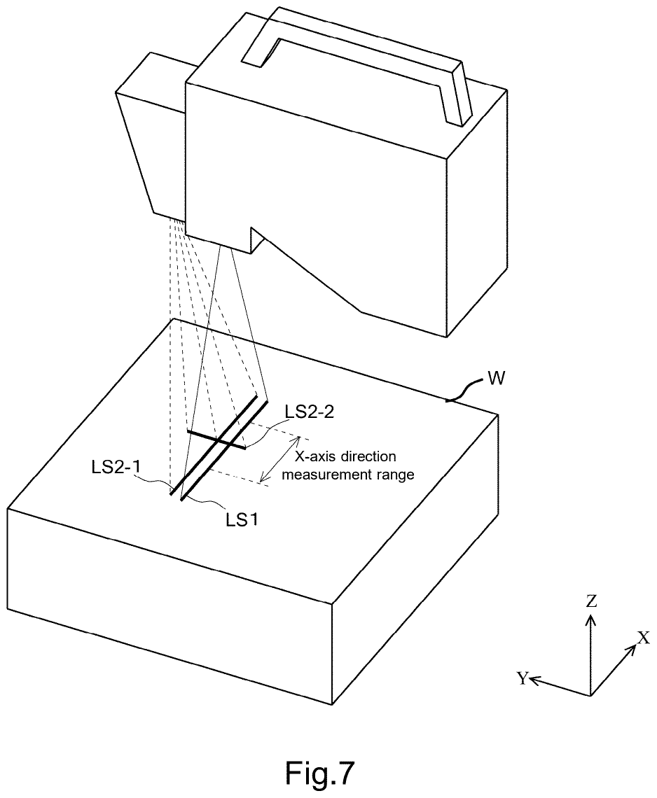

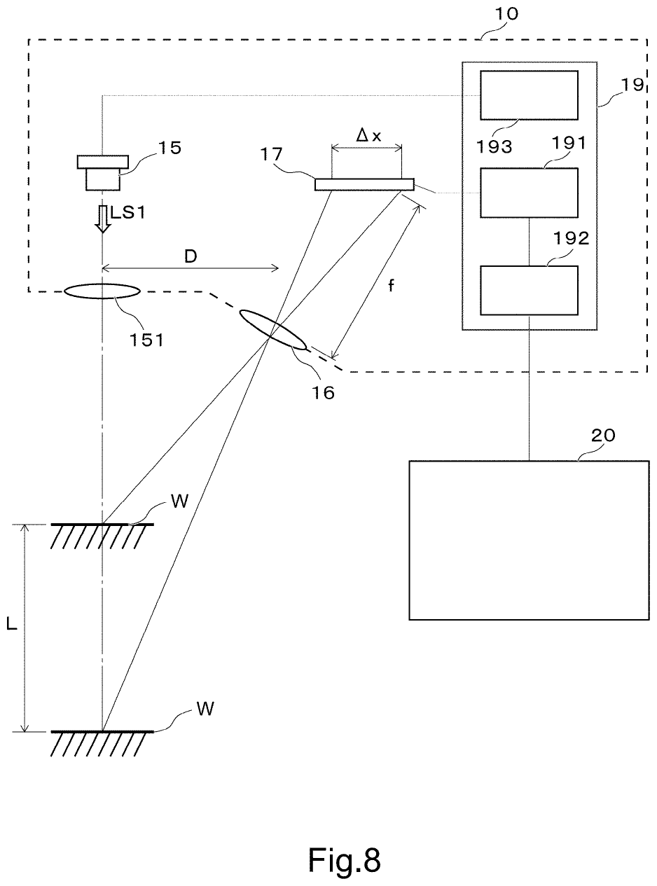

For example, though the guide light source 18 emitted a line laser beam as the guide light in the above embodiment, it may emit a so-called cross-line laser light comprising two line laser lights that are perpendicular to each other, as shown in FIG. 7. In this case, the guide light source 18 may be provided such that one of the two line laser lights (LS2-1) that constitutes the guide light overlaps in a line with the laser light LS1, which serves as the probe light, at the reference height, similar to the laser light LS2 in the above embodiment. This allows the user to easily adjust the height of the line laser measuring device 1 in the same manner as in the above embodiment.

Furthermore, the other of the two line laser lights (LS2-2) that constitutes the guide light may be irradiated such that it intersects perpendicularly with the laser light LS1, which serves as the probe light, at least at the reference height, at approximately the center of the X-axis direction (the direction in which the irradiation range of laser light LS1 extends linearly) detection range of the two-dimensional imager 17. This allows the user to visually confirm the center of the detection range in the X-axis direction when irradiating the laser light LS1, which serves as the probe light, onto the target area on the workpiece W. It ensures the target area is reliably positioned within the detection range of the two-dimensional imager 17.

With respect to the embodiments and modifications thereof, the following appendices are further disclosed.

(Appendix 1) A line laser measuring device comprising:
a probe light source that irradiates a target object with a probe light, which is a line laser light;
a guide light source that irradiates the target object with a guide light at an angle different from that of the probe light;
an imaging optical system that converges a reflected light, which is the probe light reflected by the target object, and forms an image;
a two-dimensional imager that receives the reflected light converged by the imaging optical system; and
a profile calculation unit that calculates, based on the imaging position of the reflected light on the receiving surface of the two-dimensional imager, a profile along the line where the probe light is irradiated on the target object based on a triangulation technique,
wherein the irradiation range of the probe light and the irradiation range of the guide light overlap at a reference height within the profile detection range of the two-dimensional imager.

(Appendix 2) The line laser measuring device according to Appendix 1, wherein the guide light is a line laser light, and the probe light and the guide light overlap in a line at the reference height.

(Appendix 3) The line laser measuring device according to Appendix 1, wherein
the guide light is a cross-line laser light comprising two line laser lights that are perpendicular to each other,
one of the two line laser lights that constitutes the guide line laser light overlaps in a line with the probe light at the reference height, and
the other of the two line laser lights that constitutes the guide light intersects perpendicularly with the probe light at least at the reference height, at approximately the center of the detection range of the two-dimensional imager in the direction in which the irradiation range of the probe light extends linearly.

(Appendix 4) The line laser measuring device according to any one of Appendices 1 to 3, wherein the wavelength of the probe light is shorter than the wavelength of the guide light.

(Appendix 5) The line laser measuring device according to Appendix 4, wherein the imaging optical system comprises an optical filter that transmits the probe light and attenuates the guide light.

(Appendix 6) The line laser measuring device according to any one of Appendices 1 to 5, wherein the probe light and the guide light are alternately irradiated.

(Appendix 7) The line laser measuring device according to any one of Appendices 1 to 6, wherein the operation of the two-dimensional imager and/or the profile calculation unit is stopped when the guide light is being irradiated.

(Appendix 8) The line laser measuring device according to any one of Appendices 1 to 7, wherein the angle formed by the probe light and the guide light is substantially equal to the angle formed by the probe light and the main optical axis of the imaging optical system.

(Appendix 9) The line laser measuring device according to any one of Appendices 1 to 8, further comprises:
a handle fixedly provided on the line laser measuring device; and
a measurement button arranged in a position operable with a finger when the handle is grasped,
   wherein the two-dimensional imager and the profile calculation unit are activated to calculate a profile while the measurement button is being manipulated.

(Appendix 10) The line laser measuring device according to any one of Appendices 1 to 9, wherein the device is configured to be mounted on a distal end portion of a robotic arm.

1. A line laser measuring device comprising:
a probe light source that irradiates a target object with a probe light, which is a line laser light;
a guide light source that irradiates the target object with a guide light at an angle different from that of the probe light;
an imaging optical system that converges a reflected light, which is the probe light reflected by the target object, and forms an image;
a two-dimensional imager that receives the reflected light converged by the imaging optical system; and
a profile calculation unit that calculates, based on the imaging position of the reflected light on the receiving surface of the two-dimensional imager, a profile along the line where the probe light is irradiated on the target object based on a triangulation technique,
wherein the irradiation range of the probe light and the irradiation range of the guide light overlap at a reference height within the profile detection range of the two-dimensional imager.

2. The line laser measuring device according to claim 1, wherein the guide light is a line laser light, and the probe light and the guide light overlap in a line at the reference height.

3. The line laser measuring device according to claim 1, wherein
the guide light is a cross-line laser light comprising two line laser lights that are perpendicular to each other,
one of the two line laser lights that constitutes the guide line laser light overlaps in a line with the probe light at the reference height, and
the other of the two line laser lights that constitutes the guide light intersects perpendicularly with the probe light at least at the reference height, at approximately the center of the detection range of the two-dimensional imager in the direction in which the irradiation range of the probe light extends linearly.

4. The line laser measuring device according to claim 1, wherein the wavelength of the probe light is shorter than the wavelength of the guide light.

5. The line laser measuring device according to claim 4, wherein the imaging optical system comprises an optical filter that transmits the probe light and attenuates the guide light.

6. The line laser measuring device according to claim 1, wherein the probe light and the guide light are alternately irradiated.

7. The line laser measuring device according to claim 1, wherein the operation of the two-dimensional imager and/or the profile calculation unit is stopped when the guide light is being irradiated.

8. The line laser measuring device according to claim 1, wherein the angle formed by the probe light and the guide light is substantially equal to the angle formed by the probe light and the main optical axis of the imaging optical system.

9. The line laser measuring device according to claim 1, further comprising:
a handle fixedly provided on the line laser measuring device; and
a measurement button arranged in a position operable with a finger when the handle is grasped,
wherein the two-dimensional imager and the profile calculation unit are activated to calculate a profile while the measurement button is being manipulated.

10. The line laser measuring device according to claim 1, wherein the device is configured to be mounted on a distal end portion of a robotic arm.
